(19) United States
(12) Patent Application Publication
(10) Pub. No.: US 2007/0174111 A1
(43) Pub. Date: Jul. 26, 2007

(54) Evaluating a performance of a customer support resource in the context of a peer group

(75) Inventors: Gary F. Anderson, Danbury, CT (US); Mark S. Ramsey, Kihei, HI (US); David A. Selby, Nr Fareham (GB)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/338,413

(22) Filed: Jan. 24, 2006

(51) Int. Cl. G06F 11/34

(52) U.S. Cl. 705/11

(57) ABSTRACT

A method, system and computer program product for evaluating a performance of an object customer support resource in providing a customer support service is disclosed. A peer group of customer support resources that are expected to behave comparably as the object customer support resource is established to determine a normal behavior that the object customer support resource is supposed to act consistent with in providing the customer support service. A behavior of the object customer support resource is compared to the normal behavior to evaluate a performance of the object customer support resource in providing the customer support service. Real time assignment of the customer support service is performed based on a result of the evaluation.

### FIELD OF THE INVENTION

The invention relates to evaluating a performance of a customer service resource.

### BACKGROUND OF THE INVENTION

Many organizations provide customer support functions, for example, account service, new product sales, or customer support using contact center agents. Large organizations may employ a large amount of customer support resources, including, e.g., customer support representatives and automatic service machines, in performing customer support services in multiple geographic locations. As such, it is desirable that the customer support services are provided in a high quality and in a consistent manner among the customer support resources to achieve management objectives including maximizing the satisfaction of a customer. To this end, efforts need to be made to understand how well a customer support resource performs and to identify factors that contribute to the highest satisfaction to a customer.

No successful solution exists in the market today to provide a method to evaluate a performance of a customer support resource regarding how well the customer support resource performs relatively to its peers, whether the customer support resource performs in a manner consistent with others and to identify behaviors that provide high satisfaction to a customer. Based on the above, there is a need to evaluate a performance of a customer support resource in the context of a peer group.

### BRIEF SUMMARY OF THE INVENTION

A method, system and computer program product for evaluating a performance of an object customer support resource in providing a customer support service is disclosed. A peer group of customer support resources that are expected to behave comparably as the object customer support resource is established to determine a normal behavior that the object customer support resource is supposed to act consistent with in providing the customer support service. A behavior of the object customer support resource is compared to the normal behavior to evaluate a performance of the object customer support resource in providing the customer support service. Real time assignment of the customer support service is performed based on a result of the evaluation.

A first aspect of the invention is directed to a method for evaluating a performance of an object customer support resource in providing a customer support service, the method comprising steps of: selecting a peer group of customer support resources that are expected to have a comparable behavior as the object customer support resource; identifying a set of behavioral attributes of the peer group; determining a normal behavior of the peer group regarding the identified set of behavioral attributes; and comparing a behavior of the object customer support resource to the normal behavior regarding the identified set of behavior attributes to evaluate the performance of the object customer support resource.

A second aspect of the invention is directed to a system for evaluating a performance of an object customer support resource in providing a customer support service, the system comprising: a means for selecting a peer group of customer support resources that are expected to have a comparable behavior as the object customer support resource; a means for identifying a set of behavioral attributes of the peer group; a means for determining a normal behavior of the peer group regarding the identified set of behavioral attributes; and a means for comparing a behavior of the object customer support resource to the normal behavior regarding the identified set of behavior attributes to evaluate the performance of the object customer support resource.

A third aspect of the invention is directed to a computer program product for evaluating a performance of an object customer support resource in providing a customer support service, the computer program product comprising: computer usable program code configured to: obtain data regarding a behavior of the object customer support resource and a pool of different customer support resources in providing the customer support service; select a peer group of customer support resources from the pool, the peer group being expected to have a comparable behavior as the object customer support resource; identify a set of behavioral attributes of the peer group; determine a normal behavior of the peer group regarding the identified set of behavioral attributes; and compare the behavior of the object customer support resource to the normal behavior regarding the identified set of behavior attributes to evaluate the performance of the object customer support resource.

A fourth aspect of the invention is directed to a method of generating a system for evaluating a performance of an object customer support resource in providing a customer support service, the method comprising: providing a computer infrastructure operable to: obtain data regarding a behavior of the object customer support resource and a pool of different customer support resources in providing the customer support service; select a peer group of customer support resources from the pool, the peer group being expected to have a comparable behavior as the object customer support resource; identify a set of behavioral attributes of the peer group; determine a normal behavior of the peer group regarding the identified set of behavioral attributes; compare the behavior of the object customer support resource to the normal behavior regarding the identified set of behavior attributes to evaluate the performance of the object customer support resource, and communicate a result of the evaluation to a user.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

The embodiments of this invention will be described in detail, with reference to the following figures, wherein like designations denote like elements, and wherein:

FIG. 1 shows a schematic view of an illustrative customer support resource performance evaluating system according to one embodiment of the invention.

FIG. 2 shows a block diagram of an illustrative computer system according to one embodiment of the invention

FIG. 3 shows a flow diagram of one embodiment of the operation of a customer support resource performance evaluation product code according to the invention.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

### 1. System Overview

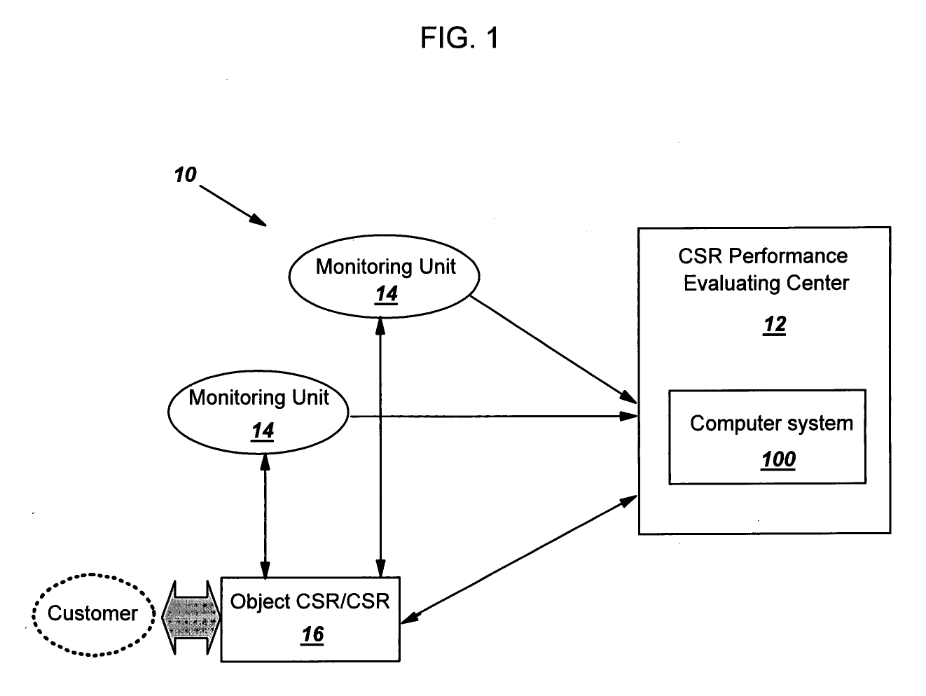

Referring to FIG. 1, a schematic view of an illustrative customer support resource performance evaluating system 10 is shown. According to one embodiment, evaluating system 10 includes a customer support resource (CSR) performance evaluating center 12 including a computer system 100; and multiple monitoring units 14 (two are shown). Monitoring units 14 detect a behavior of a customer support resource (CSR) 16 in providing a customer support service to a customer, regarding aspects that are, for example, related to management objectives such as customer satisfaction and/or efficiency. For example, if CSR 16 is an agent in a customer support contact center, monitoring units 14 may monitor duration of a phone call, whether a customer requests to talk to a supervisor, whether the issue raised by the customer is resolved, and whether the customer is satisfied after the phone call, etc. Monitoring units 14 may also monitor characteristics of the customer support services provided by CSR 16. As is understandable, behaviors of CSR 16 in providing different types of customer support services may be different.

CSR 16 communicates with evaluating center 12 regarding, for example, behaviors in providing customer support services, customer support service characteristics, and/or evaluation results. According to one embodiment, CSR 16 and monitoring units 14 communicate CSR 16 behaviors and customer support service characteristics to evaluating center 12 independently of each other. CSR 16 and monitoring units 14 may communicate the same types of information independently, or may communicate different types of information regarding CSR behaviors and customer support service characteristics. According to one embodiment, information communicated from monitoring units 14 are more heavily relied on by evaluating center 12 because fraudulent actions may be involved in the reporting of behaviors and service characteristics by CSR 16. However, some kinds of information may require CSR 16 reporting because CSR 16 is in a better position to provide the information accurately. For example, in the situation that a customer requires a non-standard service, a machine type monitoring unit 14 may not accurately classify the type of service provided (service characteristic), and CSR 16 is in a better position to categorize the nonstandard service into a standard one. Please note, monitoring units 14 may also include a person in charge of monitoring CSR 16.

CSR 16 may also communicate with monitoring units 14 in the process of monitoring. For example, CSR 16 may indicate to a monitoring unit 14 when a service begins. In evaluating system 10, an object CSR 16 is generally a CSR 16. However, for illustrative purposes only, in the following description, a CSR 16 is referred as an object CSR when the CSR's performance is evaluated by evaluating center 12, as described below. It should be noted that in evaluating system 10, regardless of whether a CSR is an object CSR 16, its behavior in providing a customer support service is always monitored because: (a) any CSR may potentially become an object CSR, and (b) any CSR may be selected into a peer group as will be described below. According to one embodiment, performances of all CSR 16 will be evaluated and ranked for further analysis. Details of computer system 100 of evaluating center 12 will be described below.

### 2. Computer System

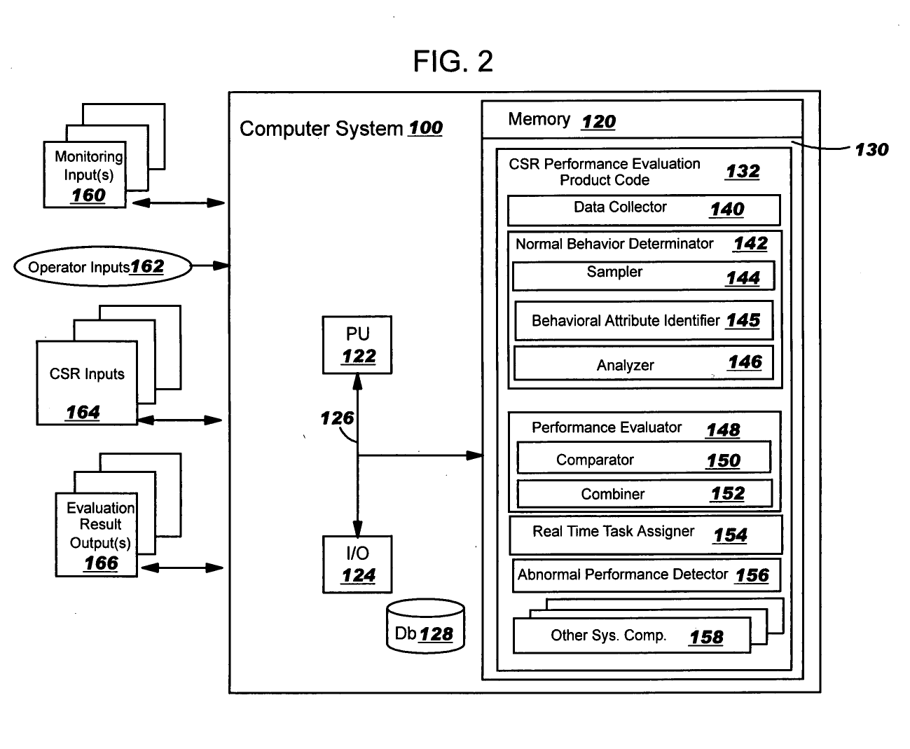

Referring to FIG. 2, a block diagram of an illustrative computer system 100 according to the present invention is shown. In one embodiment, computer system 100 includes a memory 120, a processing unit (PU) 122, input/output devices (I/O) 124 and a bus 126. A database 128 may also be provided for storage of data relative to processing tasks. Memory 120 includes a program product 130 that, when executed by PU 122, comprises various functional capabilities described in further detail below. Memory 120 (and database 128) may comprise any known type of data storage system and/or transmission media, including magnetic media, optical media, random access memory (RAM), read only memory (ROM), a data object, etc. Moreover, memory 120 (and database 128) may reside at a single physical location comprising one or more types of data storage, or be distributed across a plurality of physical systems. PU 122 may likewise comprise a single processing unit, or a plurality of processing units distributed across one or more locations. I/O 124 may comprise any known type of input/output device including a network system, modem, keyboard, mouse, scanner, voice recognition system, CRT, printer, disc drives, etc. Additional components, such as cache memory, communication systems, system software, etc., may also be incorporated into computer system 100.

As shown in FIG. 2, program product 130 may include a customer support resource (CSR) performance evaluation product code 132 that includes a data collector 140; a normal behavior determinator 142 including a sampler 144, a behavioral attribute identifier 145 and an analyzer 146; a performance evaluator 148 including a comparator 150 and a combiner 152; a real time task assigner 154; an abnormal performance detector 156; and other system components 158. Other system components 158 may include any now known or later developed parts of a computer system 100 not individually delineated herein, but understood by those skilled in the art.

Inputs to computer system 100 include monitoring inputs 160, operator inputs 162 and consumer support resource (CSR) inputs 164. Monitoring inputs 160 include the data collected by monitoring units 14 (FIG. 1). Operator inputs 162 include instructions of an operator of computer system 100 regarding the operation of, inter alia, CSR performance evaluation product code 132, as will be described in details below. Operator inputs 162 may also include characteristics of CSR 16 that are maintained, for example, for performance evaluation purpose. These CSR 16 characteristics may include, for example, geographical locations, task groups, and levels of responsibility of CSRs 16. CSR inputs 164 include CSR behavior information and service characteristic information that are reported by CSR 16 (FIG. 1). Those inputs may be communicated to computer system 100 through I/O 124 and may be stored in database 128. Outputs of computer system 100 include evaluation result outputs 166 that are communicated to, inter alia, CSR 16 and supervisors of CSR 16 for them to act accordingly. For example, CSR 16 receiving an evaluation result may improve/maintain his performance accordingly.

Please note, the full details of the evaluation procedure might not be disclosed to CSR 16 to prevent CSR 16 from committing fraudulent actions by taking advantage of the knowledge of the evaluation procedure. Please note, the input and output information listed above is not meant to be exclusive, but is provided for illustrative purpose only, and the same information may be provided by more than one kinds of inputs. For example, CSR characteristic information may be provided both by CSR inputs 164 and operator inputs 162. The operation of CSR performance evaluation product code 132 will be described in details below.

### 3. CSR Performance Evaluation Product Code

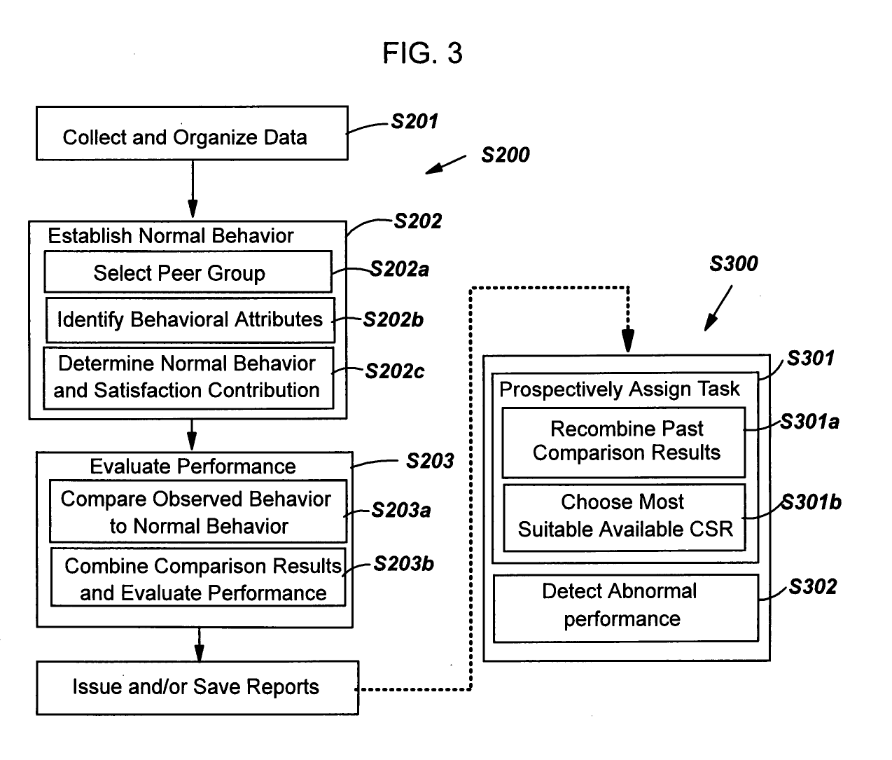

CSR performance evaluation product code 132 functions generally to evaluate a performance of CSR 16 in providing a customer support service to a customer (FIG. 1). One embodiment of the operation of CSR performance evaluation product code 132 is shown in the flow diagram of FIG. 3. In the following descriptions of the flow diagram of FIG. 3, a contact center agent is used as an illustrative example of CSR 16, for illustrative purpose only. It should be understood that CSR 16 is not limited to a contact center agent, and an evaluation of other customer support resources is similarly included in the scope of the present invention.

According to one embodiment, CSR performance evaluating center 12 (FIG. 1) evaluates the performance of object CSR 16 periodically, for example, every three months. By the end of each processing period, performance of object CSR 16 in providing a customer support service during the period (past performance) will be evaluated by CSR performance evaluation product code 132. This evaluation of past performance is referred as a historic analysis, for illustrative purpose only. In addition, CSR performance evaluation product code 132 also prospectively assigns a customer support service task to CSR 16 (FIG. 1) and identifies an abnormal behavior of an object CSR 16 during a processing period based on a result of the historic analysis. Since the prospective assignment of tasks and the identification of an abnormal behavior is performed during a processing period before an evaluation of the performance in the processing period is conducted, those operations are referred to as a prospective analysis, for illustrative purpose only. An embodiment of the operation of CSR performance evaluation product code 132 regarding the historic and prospective analyses will be shown in the flow diagram of FIG. 3.

Referring now to FIG. 3, with reference also to FIG. 2, the historic analysis of CSR performance evaluation product code 132 is show in step S200 including steps S201 to S203 and the prospective analysis is shown in step S300 including steps S301 to S302. With respect to the historic analysis, first in step S201, data collector 140 collects data and organizes the data to facilitate a further statistical analysis of the data. The data collected include those of monitoring inputs 160, operator inputs 162 and CSR inputs 164. As described above, data collector 140 collects data of all CSRs 16 in a processing period. According to one embodiment, the data collected may be categorized as including CSR performance data, CSR characteristic data, and service characteristic data. CSR performance data may include data regarding factors that indicate a performance of CSR 16, such as, in the case of a contact center agent, time to answer, length of a call, whether the call requires a transfer to another agent or supervisor, and whether the issue of the call is resolved to the customer's satisfaction. These factors that indicate CSR 16 performance will be referred to as performance indicators, and the data value regarding each performance indicator is referred to as a behavior of CSR 16 regarding this specific performance indicator. As is understandable, a performance of CSR 16 is represented by the behaviors regarding the performance indicators.

For each specific CSR 16 (FIG. 1), the CSR performance data might have some problems such as missing data or obviously strange data. Those problems need to be resolved by data collector 140 in step S201 before the problematic data is used for further analysis. CSR performance data may also need to be treated in step S201 to fit an analysis purpose. For example, in some situations, a categorized type of data might be more suitable than a data of continuous value, so continuous CSR performance data may need to be converted to categorized data in step S201.

CSR characteristic data include data regarding characteristics of a CSR 16 that affect the performance of the CSR (16). As is understandable, CSR 16 characteristics are generally related to CSR performance indirectly, i.e., they do not directly indicate performance, instead they affect performance. For example, a lower level contact center agent tends to (and is expected to) behave differently than a higher level agent because of, for example, their different responsibilities. Different locations of contact centers also tend to predict different performances of the agents therein, due to, for example, different management policies regarding the practices in the contact centers. Service characteristic data also affect CSR 16 performance because, as is understandable, CSR 16 tends to behave differently in providing different types of customer support services.

Next in step S202, normal behavior determinator 142 determines a normal behavior that object CSR 16 is expected to behave consistent with in providing a customer support service. The normal behavior is determined by analyzing a peer group of CSRs 16 having the same (or similar) user characteristics and providing the same (or similar) customer support service as object CSR 16. Specifically, in step S202a, sampler 144 establishes/selects a peer group of CSRs 16 having the same (or similar) user characteristics and providing the same (or similar) customer support service as object CSR 16, whose performances are thus generally expected to be comparable to that of object CSR 16 regarding the same (or similar) customer support service. Here, the meaning of behaving comparably regarding the customer support service includes, but is not limited to, comparable behavior (i.e., data value) regarding each performance indicator. It is understandable that other manners of defining comparable behavior are also included in the present invention. The selection of the peer group may be dependent upon which manner of defining behaving comparably is used. In the operation of CSR performance evaluation product code 132, an operator of computer system 100 may instruct evaluation product code 132 regarding how to define behaving comparably for a specific kind of object CSR 16 in providing a specific kind of customer support service, through operator inputs 162.

It should be noted that other factors, such as performance indicators, may also be used, independently or together with the CSR characteristic data and the service characteristic data, to select peer groups. For example, a group of CSRs (16) having comparable behaviors regarding some of the performance indicators may be expected to have comparable behaviors regarding the other performance indicators. In the following description, however, selection of a peer group using the CSR characteristic data and the service characteristic data is used as an illustrative example, for descriptive purpose only.

It should also be noted that the selection of a peer group is performed by evaluation product code 132, specifically sampler 144, independent of interventions of object CSR 16. According to one embodiment, no information regarding the peer group selection, for example, standard, procedure, and/or results, will be communicated to object CSR 16. This is to ensure that object CSR 16 and other CSRs 16 having the potential of being selected into a peer group will not coordinate in a fraudulent type of actions, which will be more difficult to detect.

According to one embodiment, in step S202a, sampler 144 first identifies a pool of all the CSRs 16 who have the same (or similar) CSR characteristics as object CSR 16 and provide the same (or similar) customer support services. Next, sampler 144 samples a peer group from the pool. One reason for sampling a peer group from the pool is to save system resources of computer system 100 (FIG. 2), for example, the memory space required for further calculation. It should be understood that in some situations, sampling may not be necessary or may not be desirable. For example, if the pool itself is not big or if the potential sampling errors are not acceptable, the pool of all the CSRs having the same (or similar) CSR characteristics and providing the same (or similar) customer support service as object CSR 16 may be used as the peer group. The sampling may use any now known or future developed methods of sampling, for example, random sampling or representative sampling.

Next in step S202b, behavioral attribute identifier 145 identifies a set of performance indicators, regarding which object CSR 16 is expected to behave comparably as the peer group identified in step S202a. The identified set of performance indicators is referred to as behavioral attributes, for illustrative purpose only. For a specific object CSR 16, it may not be expected that he/she/it behaves comparably to the peer group regarding all performance indicators, instead it may be expected that object CSR 16 behaves comparably to the peer group regarding some performance indicators. In addition, even if object CSR 16 is expected to behave comparably regarding all performance indicators, not all performance indicators are of concern for object CSR 16 in a specific evaluation. For example, one evaluation of object CSR 16 performance may focus more on efficiency and another evaluation may focus more on responsiveness to customer requests.

According to one embodiment, the selection of behavioral attributes may be based on statistical analysis of the behaviors of the selected peer group regarding performance indicators. For example, a standard deviation of the peer group behaviors regarding a specific performance indicator may be compared to a threshold, for example, standard deviation being less than 10 percent of mean. If the standard deviation of the peer group behaviors regarding a specific performance indicator meets the threshold, that specific performance indicator may be selected as a behavioral attribute.

According to an alternative embodiment, the selection of behavioral attributes may be based on established performance standards or policy. For example, if based on past evaluations, it is established that a set of performance indicators, for example, length of a call, responsiveness, and whether a call requires transfer to supervisor, contributes to customer satisfaction of a contact center agent (CSR 16), this set of performance indicators may be selected as the behavioral attributes. It should be noted that any now known or later developed methods of selecting behavior attributes are also included in the current invention and may be used independently, or in combination, in selecting behavioral attributes.

Next in step S202c, analyzer 146 determines a normal behavior of the peer group selected for object CSR 16 in step S202a, regarding the set of behavioral attributes identified in step S202b. In step S202c, analyzer 146 may also determine a contribution of the behavioral attributes to a desired management objective. The desired management objective is usually a preferable behavior regarding a behavioral attribute, such as customer satisfaction.

Various methods may be used to determine the normal behavior. According to one embodiment, the average of the behaviors of the peer group regarding a behavioral attribute may be selected as the normal behavior regarding this behavioral attribute. According to one example, CSR performance data of CSR 16 regarding a behavioral attribute during a whole processing period is first averaged to obtain a behavior of CSR 16 (average data) regarding the behavioral attribute in the processing period. For example, if a contact center agent (CSR 16) answers 100 calls during a processing period, the average length of the 100 calls is used to indicate the behavior of the contact center agent (CSR 16) regarding length of a call as a behavioral attribute. The average of the peer group regarding a behavioral attribute may be either the mean or the median depending on a specific object CSR 16 and a specific evaluation. According to one embodiment, the mean of the behaviors of the peer group of CSRs 16 is a better choice to be used as the normal behavior because a standard deviation is calculated based on the mean, instead of the median. As will be described below, a standard deviation may be used in further analysis. It should be noted that any now existing and later developed methods of determining a normal behavior are included in the scope of the present invention.

According to one embodiment, contribution of the behavioral attributes to a desired management objective is determined by determining a statistical relationship between the desired management objective and the behavioral attributes, such as a correlation table or a regression equation. For example, if customer satisfaction is a desired management objective and customer satisfaction is related to length of a call and responsiveness of a CSR, the contribution of length of a call and CSR responsiveness to customer satisfaction may be described in a regression equation as follows:
Satisfaction=A*Length of Call+B*Responsiveness (1)
Wherein the values of A and B can be obtained by statistically analyzing the CSR performance data of the peer group selected. According to one embodiment, in obtaining equation (1), performance data regarding each individual service (individual data), e.g, a service call by a contact center agent, provided by CSR 16 of the peer group may be used in the analysis. As is understandable, in determining a relationship between and among behavioral attributes (performance indicators), individual data is preferable to average data because, for example, individual data represents the relationship more accurately. However, it should be noted that using average data in analyzing relationships between and among behavioral attributes, e.g., equation (1), is similarly included in the present invention.

In the above description, customer satisfaction is used as an illustrative example of a desired management objective, it should be noted that contributions to other desired management objectives can be similarly determined, which is included in the present invention. For example, efficiency in providing customer support service may also be a desired management objective. As is understandable, a determined contribution to a desired management objective may be used to train CSR 16 and may be used to make performance standards for CSR 16 to follow in providing customer support service in the future.

In the above illustrative embodiment, the determination of the contribution of the behavioral attributes to a desired management objective is performed in step S202c. It should be noted that this conduction of this determination may not follow the order of steps shown in FIG. 3. For example, the contribution determination may be performed before step S202b using data of all the performance indicators (instead of the identified behavioral attributes) and the results of the determination may be used to select behavioral attributes. For example, if length of a call and responsiveness are determined contributing (substantially) to customer satisfaction, a desired management objective, length of a call, responsiveness and customer satisfaction may be selected as the behavioral attributes.

Next in step S203, performance evaluator 148 evaluates a performance of object CSR 16. Specifically, in step S203a, comparator 150 compares the behavior of object CSR 16 with the normal behavior determined in step S202 regarding the identified set of behavioral attributes. The specific procedure of the comparison depends on how the normal behavior is determined in step S202c. According to one embodiment, if the normal behavior is determined using the mean of the peer group behaviors regarding each identified behavioral attribute, comparator 150 compares the behavior of object CSR 16 with the normal behavior with respect to each of the identified set of behavioral attributes. The difference between the behavior of object CSR 16 and the normal behavior with respect to each behavioral attribute may be converted into a 0 to 1000 score. The manner of conversion may be selected to ensure that a more deviant behavior obtains a higher score. Any now known or future developed score normalization procedures may be used in the conversion. Because the details of the conversion are not necessary for an understanding of the invention, further details will not be provided.

According to one embodiment, especially if the behavior regarding a behavioral attribute can not be easily classified as good or bad, a lower score is considered a better performance because a lower score means less deviant behavior. As described above, it is preferable that customer support services are provided in a consistent manner, i.e., less deviant.

According to an alternative embodiment, especially if the behavior regarding a behavioral attribute can be classified as good or bad, a indicator of “+” or “−” may be assigned to the score to indicate whether object CSR 16 behaves better or worse than the normal behavior. For example, if object CSR 16 behaves better than the normal behavior, e.g., more customer satisfaction, a “−” may be assigned to the score. On the other hand, if object CSR 16 behaves worse than the normal behavior, e.g., less customer satisfaction, a “+” may be assigned to the score. As a consequence, a lower score still indicates a better performance and the scores obtained through this embodiment and through the above embodiment are capable of being combined in a consistent manner.

Next in step S203b, combiner 152 combines the comparison results, i.e., the scores, with respect to individual behavioral attributes to generate an overall comparison result, i.e., a combined score. The combined score may be compared to a threshold to determine whether object CSR 16 is qualified to continue to provide the specific customer support service. The combined score may also be used to identify the best performance CSR 16. For example, a CSR 16 with the lowest combined score is considered the most suitable CSR for a specific customer support service. Please note, in the embodiment described, the peer group is selected based on, inter alia, service characteristics and the evaluation is customer support service specific.

According to one embodiment, the combined score is obtained by averaging the scores obtained regarding individual behavioral attribute. According to an alternative embodiment, the score with respect to each behavioral attribute is first weighed according to the behavioral attribute's relative importance in evaluating performance before the score is combined with others to obtain a combined score. For example, customer satisfaction may be decided as a more importance indicator of performance than efficiency and may be weighed more than efficiency in the combination.

Based on the combined scores obtained in step S203b, the performances of CSRs 16 may be ranked in a list, which may be saved in database 128 for further use in a prospective analysis, as will be described below. The results of the evaluation, i.e., the combined scores, the individual scores, and the rank, may be communicated to, for example, a CSR 16 and his/her supervisor through, for example, evaluation results outputs 166. In addition, if the operation of CSR performance evaluation product code 132 is provided as a service to a user/customer, the results of the evaluation, including the rank, the individual scores, and the combined scores, may be communicated to the user/customer through evaluation results outputs 166.

Next in step S300, a prospective analysis is performed. According to the embodiment shown in FIG. 3, the prospective analysis step S300 includes two independent steps S301 and S302. Please note, step S300 occurs during a processing period, when performance data of CSR 16 has not been collected completely. As such, historic analysis results of past processing periods are used as a basis of the prospective analysis. In the following description, the historic analysis results of past processing periods are referred to as past results (or past scores), for illustrative purpose only. In step S301, real time task assigner 154 prospectively assigns a customer support service task to the available most suitable CSR 16 based on the past results of the historic analysis. Specifically, in step S301a, real time task assigner 154 controls combiner 152 of performance evaluator 148 to recombine the saved past scores of the historic analysis regarding each individual behavioral attributes according to, for example, a current management policy. For example, if at the time of the customer support service, a current management policy is concerned more with efficiency than with customer satisfaction, combiner 152 may recombine the past scores regarding each individual behavioral attributes by assigning more weight to efficiency than to customer satisfaction. The ranking of CSR 16 is re-determined based on the recombined scores.

Next in step S301b, real time task assigner 154 assigns an incoming task of customer support service to the available most suitable CSR 16. According to one embodiment, CSR 16 with the highest recombined score is considered the most suitable CSR 16. If this more suitable CSR 16 is not available, for example, working on another task, real time task assigner 154 will assign the task to the CSR 16 with the second highest recombined score, if the CSR 16 with the second highest recombined score is available, and so on and so forth.

In step S302, abnormal performance detector 156 detects an abnormal behavior of object CSR 16 before a performance of object CSR 16 is to be evaluated in a historic analysis operation. Specifically, according to one embodiment, abnormal performance detector 156 compares a current behavior of object CSR 16 in providing a customer support service, which is detected by, for example, monitoring units 14 (FIG. 1), with the past normal behavior of the peer group using the same procedures as step S203 as described above.

In addition, abnormal performance detector 156 compares a current behavior of object CSR 16 with the past behavior of object CSR 16 itself. The past behavior may be obtained using the behavior of object CSR 16 in the immediate preceding processing period, or may be obtained using an average of the behaviors of object CSR 16 in a series of preceding processing periods. If, in either comparison or both, the comparison result does not meet a preset threshold, the current behavior of object CSR 16 is considered abnormal. In this case, evaluation product code 132 will communicate the result to, for example, a supervisor of object CSR 16 to act accordingly. For example, the supervisor may choose to stop object CSR 16 from providing customer support service any further to avoid further bad performance. On the other hand, if the results of both comparisons meet the preset threshold, the current behavior of object CSR 16 is considered normal. In this case, no further action will be taken.

### 4. Conclusion

While shown and described herein as a method and system for evaluating a performance of a customer support resource, it is understood that the invention further provides various alternative embodiments. For example, in one embodiment, the invention provides a program product stored on a computer-readable medium, which when executed, enables a computer infrastructure to evaluate a performance of a customer support resource. To this extent, the computer-readable medium includes program code, such as CSR performance evaluation product code 132 (FIG. 2), which implements the process described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 120 (FIG. 2) and/or database 128 (FIG. 2), and/or as a data signal traveling over a network (e.g., during a wired/wireless electronic distribution of the program product).

In another embodiment, the invention provides a method of generating a system for evaluating a performance of a customer support resource. In this case, a computer infrastructure, such as computer system 100 (FIG. 2), can be obtained (e.g., created, maintained, having made available to, etc.) and one or more systems for performing the process described herein can be obtained (e.g., created, purchased, used, modified, etc.) and deployed to the computer infrastructure. To this extent, the deployment of each system can comprise one or more of: (1) installing program code on a computing device, such as computing system 100 (FIG. 2), from a computer-readable medium; (2) adding one or more computing devices to the computer infrastructure; and (3) incorporating and/or modifying one or more existing systems of the computer infrastructure, to enable the computer infrastructure to perform the process steps of the invention.

In still another embodiment, the invention provides a business method that performs the process described herein on a subscription, advertising supported, and/or fee basis. That is, a service provider could offer to evaluate a performance of a customer support resource as described herein. In this case, the service provider can manage (e.g., create, maintain, support, etc.) a computer infrastructure, such as computer system 100 (FIG. 2), that performs the process described herein for one or more customers and communicates the results of the evaluation to the one or more customers. In return, the service provider can receive payment from the customer(s) under a subscription and/or fee agreement and/or the service provider can receive payment from the sale of advertising to one or more third parties.

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that the terms “component” and “system” are synonymous as used herein and represent any combination of hardware and/or software capable of performing some function(s).

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for evaluating a performance of an object customer support resource in providing a customer support service, the method comprising steps of:
selecting a peer group of customer support resources that are expected to have a comparable behavior as the object customer support resource;
identifying a set of behavioral attributes of the peer group;
determining a normal behavior of the peer group regarding the identified set of behavioral attributes; and
comparing a behavior of the object customer support resource to the normal behavior regarding the identified set of behavior attributes to evaluate the performance of the object customer support resource.

2. The method of claim 1, further comprising a step of detecting an abnormal behavior of the object customer support resource before a performance of the object customer support resource is to be evaluated by comparing a current behavior of the object customer support resource with at least one of:
the normal behavior of the peer group; and
a past behavior of the object customer support resource.

3. The method of claim 1, wherein the normal behavior determining step includes collecting behaviors of the peer group of customer support resources and analyzing the collected behaviors of the peer group of customer support resources regarding the identified set of behavioral attributes.

4. The method of claim 1, further including a step of assigning a customer support service task to a customer support resource based on a result of the comparing step.

5. The method of claim 1, wherein the comparing step includes steps of:
comparing the behavior of the object customer support resource with the normal behavior with respect to each of the identified set of behavioral attributes; and
combining a result of the comparison with respect to each of the identified set of behavioral attributes to generate an overall comparison result.

6. A system for evaluating a performance of an object customer support resource in providing a customer support service, the system comprising:
means for selecting a peer group of customer support resources that are expected to have a comparable behavior as the object customer support resource;
means for identifying a set of behavioral attributes of the peer group;
means for determining a normal behavior of the peer group regarding the identified set of behavioral attributes; and
means for comparing a behavior of the object customer support resource to the normal behavior regarding the identified set of behavior attributes to evaluate the performance of the object customer support resource.

7. The system of claim 6, further comprising a means for detecting an abnormal behavior of the object customer support resource before a performance of the object customer support resource is to be evaluated by comparing a current behavior of the object customer support resource with at least one of:
the normal behavior of the peer group; and
a past behavior of the object customer support resource.

8. The system of claim 6, further comprising means for collecting behaviors of the peer group of customer support resources and analyzing the collected behaviors of the peer group of customer support resources regarding the identified set of behavioral attributes.

9. The system of claim 6, further including a means for assigning a customer support service task to a customer support resource based on a result of the comparison.

10. The system of claim 6, further including:
means for comparing the behavior of the object customer support resource with the normal behavior with respect to each of the identified set of behavioral attributes; and
means for combining a result of the comparison with respect to each of the identified set of behavioral attributes to generate an overall comparison result.

11. A computer program product for evaluating a performance of an object customer support resource in providing a customer support service, the computer program product comprising:
computer usable program code configured to:
obtain data regarding a behavior of the object customer support resource and a pool of different customer support resources in providing the customer support service;
select a peer group of customer support resources from the pool, the peer group being expected to have a comparable behavior as the object customer support resource;
identify a set of behavioral attributes of the peer group;
determine a normal behavior of the peer group regarding the identified set of behavioral attributes; and
compare the behavior of the object customer support resource to the normal behavior regarding the identified set of behavior attributes to evaluate the performance of the object customer support resource.

12. The program product of claim 11, wherein the computer usable program code is further configured to detect an abnormal behavior of the object customer support resource before a performance of the object customer support resource is to be evaluated by comparing a current behavior of the object customer support resource with at least one of:
the normal behavior of the peer group; and
a past behavior of the object customer support resource.

13. The program product of claim 11, wherein the computer usable program code is further configured to analyze the data regarding the behavior of the peer group of customer support resources regarding the identified set of behavioral attributes.

14. The program product of claim 11, wherein the computer usable program code is further configured to assign a customer support service task to a customer support resource based on a result of the comparison.

15. The program product of claim 11, wherein the computer usable program code is further configured to:
compare the behavior of the object customer support resource with the normal behavior with respect to each of the identified set of behavioral attributes; and
combine a result of the comparison with respect to each of the identified set of behavioral attributes to generate an overall comparison result.

16. A method of generating a system for evaluating a performance of an object customer support resource in providing a customer support service, the method comprising: providing a computer infrastructure operable to:
obtain data regarding a behavior of the object customer support resource and a pool of different customer support resources in providing the customer support service;
select a peer group of customer support resources from the pool, the peer group being expected to have a comparable behavior as the object customer support resource;
identify a set of behavioral attributes of the peer group;
determine a normal behavior of the peer group regarding the identified set of behavioral attributes;
compare the behavior of the object customer support resource to the normal behavior regarding the identified set of behavior attributes to evaluate the performance of the object customer support resource;
communicate a result of the evaluation to a user.

17. The method of claim 16, wherein the computer infrastructure is further operable to detect an abnormal behavior of the object customer support resource before a performance of the object customer support resource is to be evaluated by comparing a current behavior of the object customer support resource with at least one of:
the normal behavior of the peer group; and
a past behavior of the object customer support resource.

18. The method of claim 16, wherein the computer infrastructure is further operable to analyze the data regarding the behavior of the peer group of customer support resources regarding the identified set of behavioral attributes.

19. The method of claim 16, wherein the computer infrastructure is further operable to assign a customer support service task to a customer support resource based on a result of the comparison.

20. The method of claim 16, wherein the computer infrastructure is further operable to:
compare the behavior of the object customer support resource with the normal behavior with respect to each of the identified set of behavioral attributes; and
combine a result of the comparison with respect to each of the identified set of behavioral attributes to generate an overall comparison result.
